(19) United States
(12) Patent Application Publication
(10) Pub. No.: US 2014/0255905 A1
(43) Pub. Date: Sep. 11, 2014

(54) MEDICAL FLUID COMPRISING GLOBULIN AND ITS USE FOR PRESERVATION OF HARVESTED ORGANS

(71) Applicant: VIVOLINE MEDICAL AB, Lund (SE)

(72) Inventor: Stig Steen, Lund (SE)

(73) Assignee: VIVOLINE MEDICAL AB, Lund (SE)

(21) Appl. No.: 14/349,259

(22) PCT Filed: Oct. 2, 2012
(86) PCT No.: PCT/SE2012/000150

§ 371 Date: Apr. 2, 2014

(30) Foreign Application Priority Data
Oct. 3, 2011 (SE) 1100726-7

(51) Int. Cl. A01N 1/02

(52) U.S. Cl. CPC A01N 1/0226
USPC 435/1.2

(57) ABSTRACT

A medical fluid for a harvested organ, tissue or parts thereof, for evaluation and/or preservation. The fluid comprise oncotic agents, comprising albumin, a dextran compound and at least one globulin. The globulin has a concentration, which is larger than physiological concentration thereof. In addition, the fluid comprises hormones, such as thyroxin; triiodotyronine; cortisone, insulin; and electrolytes and optionally nutrients in substantially physiological concentrations in a physiologically acceptable medium. Moreover, the medical fluid comprises an oxygen carrier, such as erythrocytes. Further components may be dopamine; hydrocortisone; methylprednisolone; and a vasopressor agent, such as desmopressin. Moreover, cocaine, adrenalin, and/or noradrenalin, may be present in concentrations of each about 1 nM to 100 nM, for example in a ratio of 1:1:1.

### FIELD OF INVENTION

The present invention relates to a method of handling an organ after harvesting, including a medical fluid and use of said fluid.

### BACKGROUND OF THE INVENTION

It is well known that there is a great shortage of donor organs, which are suitable for transplantation.

After harvesting, the organs should be examined and evaluated for viability to be used for transplantation purpose. The evaluation may be performed at a physiological temperature of about 37° C., such as between 30° C. and 40° C. During the evaluation, the organs may be perfused by and/or surrounded by an evaluation fluid similar to blood.

Normally, the organs cannot be transplanted directly, but a recipient should be found, which may take some time. Moreover, the organ to be transplanted should be transported to the recipient or the recipient be transported to the organ. Thus, the organs may be preserved for some hours or days, often at hypothermal conditions. During preservation, the organs may be perfused by and/or surrounded by a preservation fluid.

There are several previously known evaluation fluids and preservation fluids. Such medical fluids involve compromises between cost and performance. Medical fluids derived from blood products may transmit deceases, such as hepatitis etc.

An evaluation fluid may operate at physiological conditions and at a temperature of about 37° C. and may provide support for metabolism of the organ, at least to a certain degree. Such a fluid may be whole blood or a fluid operating similar to blood.

A preservation fluid may be optimized for operation at low temperature, during which the metabolism of the organ is low.

Thus, there is a need for a medical fluid, which is more versatile than those presently used, and which is suitable for evaluation and preservation of organs during and after harvesting and before and during transplantation.

WO2010077200A1 and WO2010077201A1 disclose fluids, which are used for the support of body functions in a brain-dead body. In addition, a medical fluid is disclosed in WO 20111/42705. The contents of these patent applications are incorporated in the present specification by reference.

U.S. Pat. No. 7,255,983B2 discloses a solution comprising serum albumin at a concentration of 55-105 g/L, a scavenger and coating compound, preferably dextran compounds and derivatives thereof having essentially the same structure at a concentration of 1-55 g/L weight, and a physiological serum concentration of salts and nutrients in a physiologically acceptable medium. The solution is called “Steen Solution”.

### SUMMARY OF THE INVENTION

Accordingly, an object of the present invention is to mitigate, alleviate or eliminate one or more of the above-identified deficiencies and disadvantages singly or in any combination.

In an aspect, there is provided a medical fluid for a harvested organ, tissue or parts thereof, for evaluation and/or preservation, which medical fluid comprises oncotic agents, comprising albumin, a dextran compound, and at least one globulin, wherein the at least one globulin has a concentration, which is larger than physiological concentration thereof.

In an embodiment, the oncotic agents are present in the concentrations: albumin, from 4.0% to 5.5%; dextran compound, from 0.1% to 4.0%.

In an embodiment, the globulin is at lest one of: IgG in a concentration of more than 20 g/L, for example 20 to 80 g/L, such as 25 to 50 g/L, for example about 30 g/L; IgA in a concentration of more than 10 g/L, for example 10 to 20 g/L, such as 10 to 15 g/L, for example about 11 g/L; alfa-2-macroglobulin in a concentration of more than 5 g/L, for example 5 to 100 g/L, such as 15 to 75 g/L, for example about 40 g/L.

The globulins may comprise immunoglobulins, in a concentration of more than 40 g/L, for example 40 to 80 g/L, such as 45 to 60 g/L, for example about 50 g/L. The immunoglobulins may comprise at least 50% IgG. The immunoglobulins may comprise at least 50% IgG and in addition at least 25% IgA and the rest of immunoglobulins may be at least one of: IgD, IgE and IgM. The globulins may comprise alfa-2-macroglobulin in a concentration of more than 5 g/L, for example 5 to 100 g/L, such as 15 to 75 g/L, for example about 40 g/L.

In another embodiment, the medical fluid may further comprise at least one of: electrolytes in substantially physiological concentrations in a physiologically acceptable medium; nutrients in substantially physiological concentrations in a physiologically acceptable medium; hormones, such as thyroxin; triiodotyronine; cortisone; and an oxygen carrier, such as erythrocytes.

In a further embodiment, the medical fluid may further comprise at least one of: glucose; insulin; dopamine; hydrocortisone; methylprednisolone; and a vasopressor agent, such as desmopressin. In addition, the medical fluid may comprise cocaine or a stimulating analogue thereof; nor-adrenalin; and/or adrenalin in concentrations of each about 1 nM to 100 nM, for example in a ratio of 1:1:1.

In a further aspect, there is provided a use of a fluid for a harvested organ, tissue or part thereof for evaluation and/or preservation, which medical fluid comprises oncotic agents, comprising albumin, a dextran compound, and at least one globulin, wherein the at least one globulin has a concentration, which is larger than physiological concentration thereof. The medical fluid may further comprise at least one of: glucose; albumin; insulin; dopamine; hydrocortisone; methylprednisolone; and a vasopressor agent, such as desmopressin; and an oxygen carrier, such as erythrocytes. In addition, the medical fluid may further comprise cocaine or a stimulating analogue thereof; nor-adrenalin; and/or adrenalin in concentrations of each about 1 nM to 100 nM, for example in a ratio of 1:1:1.

### DETAILED DESCRIPTION OF EMBODIMENTS

Below, several embodiments of the invention will be described. These embodiments are described in illustrating purpose in order to enable a skilled person to carry out the invention and to disclose the best mode. However, such embodiments do not limit the scope of the invention. Moreover, certain combinations of features are shown and discussed. However, other combinations of the different features are possible within the scope of the invention.

When an organ has been harvested, the organ may be evaluated for suitability for transplantation. Such evaluation may involve administration of a medical fluid to the vascular system of the organ during physiological conditions and physiological temperature.

If the organ is the heart, the evaluation may involve measurement of the organs ability to pump fluid. If the organ is the lungs, the organs ability to add oxygen and remove carbon dioxide may be measured. For other organs, the organs ability to operate as required may be assessed.

A medical fluid used for such purpose may be for example “Steen Solution” disclosed in WO0235929A1, the contents of which is incorporated in the present specification by reference. Such medical fluid may comprise salts and nutrients as well as human serum albumin and for example dextran compounds. In addition, erythrocytes may be added for oxygen supply. Thus, the evaluation fluid is able to support oxygenation and nutrition of the cells.

A medical fluid may be prepared based on a blood plasma product, which comprises physiological concentrations of albumin and other blood proteins. However, the use of a blood plasma product always carries the risk of transmission of blood born deceases, such as hepatitis etc.

The medical fluid according to the present invention uses components derived from blood, for example human blood. However, when single proteins, such as albumin or selected globulins are extracted, they may be rinsed and prepared from plasma shown to be non reactive for HBsAg, anti-HCV, anti-HBc, and negative for anti-HIV 1 & 2 by FDA approved tests. The use of only a few of the proteins available in blood reduces the risk of transmission of deceases.

During the evaluation, there is always a risk that the organ forms edema or increase its water content, such as swelling. Thus, an oncotic agent or oncotic agents are added to the medical fluid in order to generate a sufficient oncotic pressure to prevent edema formation.

In the above-mentioned “Steen Solution”, human serum albumin and Dextran-40 are used in combination. In an example, the oncotic agents are 70 g/L of human serum albumin and 5 g/L of Dextran-40. In another example, the oncotic agents are 64 g/L of Albumin Centeon and 5 g/L of Dextran-40.

In both examples, the albumin concentration is well above the physiological level of albumin in human blood, which normally is about 35 g/L to about 55 g/L. While this increased level of albumin concentration may be well accepted by the organs during both evaluation and preservation at different temperatures, there are occasions when a lower albumin concentration would be desirable of different reasons.

One such reason may be that albumin at high concentration may pass out from the blood vessels into the interstitial fluid of the organ and accumulate therein, which may be detrimental for the subsequent implantation process and subsequent function of the organ after implantation.

Thus, there is a need for at least a partial replacement for the portion of albumin, which is above the physiological level.

In the prior art, a dextran compound, such as Dextran-40 or Dextra-70 is used for providing additional oncotic pressure. Dextran has the additional advantage of partially coating the endothelium of the blood vessels of an organ, which prevents damage of the blood vessels and the sensitive endothelial cells thereof.

In the human blood, albumin is responsible for about 75-85% of the oncotic pressure, the balance being provided by other blood proteins. The oncotic pressure is inversely related to the size of the protein.

Several of the blood proteins are non-desired in a medical fluid for perfusion of an organ intended for implantation. Thus, many of the blood proteins are involved in the coagulation process. In order to use such blood proteins, a non-clotting agent such as heparin is required.

However, there is a tendency in the art to avoid all use of other blood proteins than albumin in medical fluids, wherein contact with a living patient will happen, such as in an organ to be transplanted.

However, according to the present invention, it has been found that certain globulins may be used for providing a partial oncotic pressure in addition to albumin.

Thus, a medical fluid may comprise as oncotic agents; physiological concentrations of albumin, a dextran compound, and globulins, wherein the globulin is present in a concentration, which is higher than the normal physiological concentration of the globulin.

A suitable globulin is gamma globulin. The most significant gamma globulins are immunoglobulins (“Igs”), more commonly known as antibodies, although some Igs are not gamma globulins, and some gamma globulins are not Igs.

Immunoglobulin G, IgG, has a molecular weight of about 150,000. The physiological concentration is about 8 to 18 g/L. Except for IgA, the other immunoglobulins IgD, IgE and IgM all have a molecular weight, which is larger than for IgG and thus do not normally contribute appreciably to the oncotic pressure.

IgG may be present in the medical fluid in a concentration of more than 20 g/L, for example 20 to 80 g/L, such as 25 to 50 g/L, for example about 30 g/L.

Immunoglobulin A, IgA, is the most abundant immunoglobulin in body fluids and the second most abundant immunoglobulin in plasma, found at a concentration of 0.4 to 4 g/L. IgA has a molecular weight of about 170,000.

IgA may be present in the medical fluid in a concentration of more than 10 g/L, for example 10 to 20 g/L, such as 10 to 15 g/L, for example about 11 g/L.

Another globulin is alfa-2-macroglobulin, which has a molecular weight of about 725,000. The physiological concentration is about 2.4-2.9 g/L. This globulin may be added in a large concentration, whereby it exerts a useful contribution to the oncotic pressure.

Alfa-2-macroglobulin may be present in a concentration of 5 to 100 g/L, such as 15 to 75 g/L, for example about 50 g/L.

One example of a medical fluid according to an embodiment may have oncotic agents comprising the following: 45 g/L of albumin, 30 g/L of IgG and 10 g/L of Dextran-40.

In addition, the medical fluid may comprise normal physiological concentrations of electrolytes and nutrition agents, for example as disclosed in WO0235929A1.

In another example, the oncotic agents have the following composition: 50 g/L of albumin, 25 g/L of IgG, 11 g/L of IgA and 5 g/L of Dextran-40.

In a further example, the oncotic agents have the following composition: 40 g/L of albumin, 40 g/L of IgG and 10 g/L of Dextran-40.

In a still further example, the oncotic agents have the following composition: 45 g/L of albumin, 30 g/L of immunoglobulins, and 10 g/L of Dextran-40. The immunoglobulins may comprise IgG and IgA and possibly at least one of IgD, IgE and IgM. This solution will have approximately the same oncotic pressure as the “Steen Solution” example mentioned above wherein the oncotic agents are 70 g/L of human serum albumin and 5 g/L of Dextran-40.

Immunoglobulins seem to have a beneficial effect on albumin and complements albumin for providing a medical fluid, which does not influence upon the organ in a negative way. It seems that albumin, immunoglobulins and a dextran compound have synergistic effects.

In addition, the organ seems to tolerate concentrations of the immunoglobulins above physiological levels.

In addition, alfa-2-macroglobulin may be added to the medical fluid in large amounts without causing any detrimental effects.

Alfa-2-macroglobulin may be complemented by immunoglobulins or added separately to albumin and dextran.

The solution may also comprise erythrocytes.

The erythrocytes may be added shortly before use.

The medical fluid according to embodiments may be used for any organ, tissue or parts thereof and will have beneficial effects, for example will reduce edema formation.

In particular, the heart will benefit by the medical fluid according to the above examples and combinations.

In addition, it has been found that pulmonary edema may decrease by the use of the medical fluid in lung evaluation and preservation, which will improve the result of subsequent pulmonary transplantation.

The same is true for other organs, such as kidney, liver, pancreas, small bowels, intestines, etc.

The medical fluid may further contain additional components such as at least one of: hormones, such as thyroxin (T4), triiodotyronine (T3); cortisone; electrolytes and optionally nutrients in substantially physiological concentrations in a physiologically acceptable medium; and an oxygen carrier, such as erythrocytes; further hormones or substances, such as insulin; dopamine; hydrocortisone; methylprednisolone; and a vasopressor agent, such as desmopressin, or Minirin.

The erythrocytes may be replaced by synthetic oxygen carriers.

Dopamine may be added in quantities corresponding to an infusion of less than about 0.01 mg/kg/min.

Hormones should be added as required. It has been found that the hormones thyroxin (T4), triiodotyronine (T3), and cortisone are reduced rapidly in the harvested organ, and may be replaced and included in the medical fluid. Further hormones may be added as needed, such as insulin. Vasopressin may also be rapidly reduced in the harvested organ and may be included in the medical fluid, for example Desmopressin or Minirin.

Electrolytes and optionally nutrients are included in the medical fluid. Electrolytes are for example those included in Kreb's solution. Nutrients may be physiologically acceptable carbohydrates, such as glucose, fatty acids and amino acids or any combinations thereof.

Further substances may be added, such as antibiotics.

In particular for evaluation of the heart, the solution may comprise noradrenaline and/or adrenaline, with possible addition of cocaine.

The embodiments also relate to a medical fluid comprising the composition as defined above dissolved in a pharmaceutical acceptable medium. Examples of acceptable mediums are physiological sodium chloride solution, Hartmann's solution and Ringer's (acetate) solution or sterile, non-ionic water, i.e. pure H₂O.

One embodiment of the medical fluid may have the following composition:

1) The basis is a Kreb's solution, comprising for example NaCl, 110-135 mM; NaHCO3, 15-35 mM; KCl, 2.5-4.6 mM; MgCl₂, 1.0-2.6 mM; CaCl₂, 1.5-2.4; NaH₂PO₄, 1.0-2.0 mM; Glucose 1-15%, such as about 10%. KCl may be 15-25 mM or as high as 125 mM if a cardioplegic fluid is required.

2) Albumin, between 1.0% and 5.5%, such as 4.0%

3) Dextran 40, between 0.1% and 4.0%, such as 0.5%

4) Globulins, see above.

5) T3/T4, vasopressin and cortisone, each 0.1 μM

6) Erythrocytes to a hematocrit of 0% to 25%, such as 15%

Erythrocytes may be replaced by synthetic oxygen carriers.

Dextran 40 may be partly or entirely replace by Dextran 70 or another Dextran compound and/or derivatives thereof. By “dextran compound” is intended Dextran 40, Dextran-70 or another Dextran compound and/or derivatives thereof.

When the organ has been evaluated by any known method and using the medical fluid, the organ may be preserved awaiting transplantation. Such preservation often takes place in a hypothermic condition, such as a temperature below 20° C., for example below 15° C., such as about 10° C. During hypothermic conditions, the metabolism of the cells of the organ is reduced.

The medical fluid may be provided without erythrocytes, which are added shortly before use.

The medical fluid may be provided without an oncotic agent or agents, which are added shortly before use, such as a combination of albumin and a Dextran compound and globulins.

The evaluation and preservation may take place by arranging the organ in a device, such as the device disclosed in WO2009136838A1, the contents of which are incorporated in the present specification by reference.

The organ may be partly or completely immersed in the fluid. In addition or alternatively, the fluid may be introduced into the vascular system of the organ and be circulated there through.

Since the evaluation may take place at a physiological temperature, nutrients, hormones and other substances may be consumed, and need to be replaced intermittent or continuously to maintain the concentration thereof. During hypothermic preservation, replacement may not be required.

There is no strict distinction between a preservation fluid and an evaluation fluid. Thus, the same medical fluid may be used for evaluation and preservation purposes.

In the claims, the term “comprises/comprising” does not exclude the presence of other elements or steps. Furthermore, although individually listed, a plurality of means, elements or method steps may be implemented by e.g. a single unit. Additionally, although individual features may be included in different claims or embodiments, these may possibly advantageously be combined, and the inclusion in different claims does not imply that a combination of features is not feasible and/or advantageous. In addition, singular references do not exclude a plurality. The terms “a”, “an”, “first”, “second” etc do not preclude a plurality. Reference signs in the claims are provided merely as a clarifying example and shall not be construed as limiting the scope of the claims in any way.

Although the present invention has been described above with reference to specific embodiment and experiments, it is not intended to be limited to the specific form set forth herein. Rather, the invention is limited only by the accompanying claims and, other embodiments than those specified above are equally possible within the scope of these appended claims.

1. A medical fluid for a harvested organ, tissue or parts thereof, for evaluation and/or preservation, which medical fluid comprises oncotic agents, including albumin, a dextran compound, and at least one globulin, wherein the at least one globulin has a concentration, which is larger than physiological concentration thereof.

2. The medical fluid according to claim 1, wherein the oncotic agents are present in the concentrations:
albumin, from 4.0% to 5.5%
dextran compound, from 0.1% to 4.0%.

3. The medical fluid according to claim 1, wherein the globulins comprise:
IgG in a concentration of more than 20 g/L, for example 20 to 80 g/L, such as 25 to 50 g/L, for example about 30 g/L.

4. The medical fluid according to claim 1, wherein the globulins consist of immunoglobulins, in a concentration of more than 40 g/L, for example 40 to 80 g/L, such as 45 to 60 g/L, for example about 50 g/L.

5. The medical fluid according to claim 4, wherein the immunoglobulins comprise at least 50% IgG.

6. The medical fluid according to claim 5, wherein the immunoglobulins comprise at least 50% IgG and in addition at least 25% IgA and the rest of immunoglobulins is at least one of: IgD, IgE and IgM.

7. The medical fluid according to claim 1, wherein the globulins consist of alfa-2-macroglobulin in a concentration of more than 5 g/L, for example 5 to 100 g/L, such as 15 to 75 g/L, for example about 40 g/L.

8. The medical fluid according to claim 1, further comprising at least one of:
electrolytes in substantially physiological concentrations in a physiologically acceptable medium;
nutrients in substantially physiological concentrations in a physiologically acceptable medium;
hormones, such as thyroxin; triiodotyronine; cortisone; and
an oxygen carrier, such as erythrocytes.

9. The fluid according to claim 1, further comprising at least one of: glucose; insulin; dopamine; hydrocortisone; methylprednisolone; and a vasopressor agent, such as desmopressin.

10. The fluid according to claim 1, further comprising cocaine or a stimulating analogue thereof; nor-adrenalin; and/or adrenalin in concentrations of each about 1 nM to 100 nM.

11. A method for evaluation and/or preservation of a harvested organ, tissue or part thereof, comprising perfusion of the organ, tissue or part thereof by a medical fluid, which includes oncotic agents, comprising albumin, a dextran compound, and at least one globulin, wherein the at least one globulin has a concentration, which is larger than physiological concentration thereof

12. The method according to claim 11, wherein the fluid further comprises:
at least one of glucose; insulin; dopamine; hydrocortisone; methylprednisolone; and a vasopressor agent, such as desmopressin; and an oxygen carrier, such as erythrocytes.

13. The method according to claim 11, wherein the fluid further comprises:
cocaine or a stimulating analogue thereof; nor-adrenalin and/or adrenalin in concentrations of each about 1 nM to 100 nM.

14. The method according to claim 11, wherein the globulins comprise:
IgG in a concentration of more than 20 g/L, for example 20 to 80 g/L, such as 25 to 50 g/L, for example about 30 g/L.

15. The method according to claim 11, wherein the globulins comprise:
IgA in a concentration of more than 10 g/L, for example 10 to 20 g/L, such as 10 to 15 g/L, for example about 11 g/L.

16. The method according to claim 11, wherein the globulins comprise:
alfa-2-macroglobulin in a concentration of more than 5 g/L, for example 5 to 100 g/L, such as 15 to 75 g/L, for example about 40 g/L.

17. The medical fluid according to claim 1, wherein the globulins comprise:
IgA in a concentration of more than 10 g/L, for example 10 to 20 g/L, such as 10 to 15 g/L, for example about 11 g/L.

18. The medical fluid according to claim 1, wherein the globulins comprise:
alfa-2-macroglobulin in a concentration of more than 5 g/L, for example 5 to 100 g/L, such as 15 to 75 g/L, for example about 40 g/L.
